(19) United States
(12) Patent Application Publication
(10) Pub. No.: US 2021/0112795 A1
(43) Pub. Date: Apr. 22, 2021

(54) FISHING LINE GUIDE

(71) Applicant: CAXIN TECHNIQUES CORP., Tainan City (TW)

(72) Inventor: Kung-Yi HUANG, Tainan City (TW)

(21) Appl. No.: 16/654,523

(22) Filed: Oct. 16, 2019

(51) Int. Cl. A01K 87/04

(52) U.S. Cl. CPC A01K 87/04

(57) ABSTRACT

The invention provides a fishing line guide which comprises a fixing part, a bending part connected with the fixing part, a ring frame connected with the bending part, and a guide ring channel penetrating through the ring frame and allowing a fishing line to pass through. The ring frame comprises a protrusion extending opposite to the fixing part, an inner surface of the protrusion is provided with a line guide surface, and the protrusion and the line guide surface are integrally formed and drawn from the ring frame in a stamping manner.

### FIELD OF THE INVENTION

The invention relates to a fishing line guide, in particular to an integrally formed fishing line guide.

### BACKGROUND OF THE INVENTION

Among fishing tackles, the fishing line guide has the functions of limiting the fishing line angle, guiding the fishing line to position, and providing supporting force and the like, and the top guide at the tail end of the fishing rod serves as a place where the fishing line is stressed when being pulled by fishes. When a fish is hooked, the line would be held tightly against the guide ring by pulling force. At this time, the contact part of the fishing line and the guide ring bears quite high a force, so that the stress resistance and the friction resistance of the guide ring need to be improved. A fixing member of a fishing line guide is mentioned in Taiwan Publication No. I583305, which allows the fishing line guide to be simply mounted with the fishing line guide. This document discloses a fishing line guide comprising a frame. The frame is composed of a front fiber-reinforced resin layer and a rear fiber-reinforced resin layer, wherein the front fiber-reinforced resin layer comprises a ring holding part mounted with a guide ring through which a fishing line is inserted, and a holding hole formed through the frame and fastening one top end of a front thin rod fixed to the fishing rod; and the rear fiber-reinforced resin layer comprises a leg part, which is bifurcated from the ring holding part of the front fiber-reinforced resin layer and fixed to a fishing rod fixing part of the rod, and is formed at one top end, and a reinforcing sheet which disposed continuously and throughout the front fiber-reinforced resin layer and the rear fiber-reinforced resin layer. Therefore, the guide provides advantages of reducing the weight and improving flexibility of the guide.

The description of the mentioned case refers to: “the guide ring 9 fitted into these openings 5c, 6c may have a shape of a ring and may be formed of, e.g., titanium, aluminum, SUS, ceramic, so as to have a small sliding resistance at the line guiding surface 9a (inner circumferential surface) thereof”. The inner edge of the line guiding surface 9a is a segment of circular arc surface, and the instantaneous force of the fishing line is reduced to avoid cutting off the fishing line when the fishing line is stressed and inclined at a large angle. However, the conventional line guide is an assembly which is made in a manner that the guide ring 9 is subsequently machined and inserted after the openings 5c, 6c are formed. The structure of guide ring 9 is complex and is not easy to manufacture in production. In addition, ceramic elements are also fitted into a fishing line ring for reinforcing the circular arc structure of the fishing line ring. However, the ceramic element needs to be tightly matched with a ring frame of the fishing line ring, and also the ceramic may be broken as inserted due to the brittleness of the ceramic. Thus, the cost is increased due to the complicated process. Therefore, how to ensure the circular arc surface of the inner edge of the fishing line guide maintaining good quality while reducing the manufacturing cost is an urgent problem to be solved in the art.

### SUMMARY OF THE INVENTION

The invention aims to solve the problems in the prior art that a circular arc surface component which is arranged on an inner edge of a fishing line guide and a ring frame are two separate components, and defects are caused in the combination process. Therefore, the fishing line guide is simplified integrally formed, the defective rate and the cost of the manufacturing process would be reduced, and the fishing line guide is not easy to damage while using.

In order to achieve the object, the invention provides a fishing line guide which comprises a fixing part, a bending part connected with the fixing part, a ring frame connected with the bending part, and a guide ring channel penetrating through the ring frame and allowing a fishing line to pass through. The ring frame comprises a protrusion extending opposite to the fixing part, an inner surface of the protrusion is provided with a line guide surface, and the protrusion and the line guide surface are integrally formed and drawn from the ring frame in a progressive stamping manner.

Further, the surface of the ring frame is coated with a reinforcing layer.

Therefore, compared with the prior art, the invention has the following beneficial effects:

according to the fishing line guide of the present invention, the line guide surface with the arc-shaped edge of the inner bulge is formed without embedding or assembling processes. The ring frame and the line guide surface are integrally formed. The component manufactured by stamping, stretching and forging not only provides advantage of improving the manufacturing process, but also achieves the beneficial effects of lightening, changing the radian of the component according to requirements, improving the applicability and the like. Further, the factors of defective rate caused by the complicated manufacturing process and a fragile ceramic part would be avoided.

### BRIEF DESCRIPTION OF THE DRAWINGS

FIG. 1 is a perspective view of a first embodiment of the present invention.

FIG. 2 is a perspective view from another angle of the first embodiment of the present invention.

FIG. 3 is a perspective view of combining a fishing line guide according to the present invention with a fishing rod.

FIG. 4 is a perspective view for using the fishing line guide according to the present invention combining with the fishing rod.

### DETAILED DESCRIPTION OF THE PREFERRED EMBODIMENTS

Several preferred embodiments for the technical features and modes of operation of the present application are described below with reference to the drawings. Moreover, regarding the proportions in the drawings of the present invention is not necessary to be drawn to scale, and not to limit the scope of the invention as claimed.

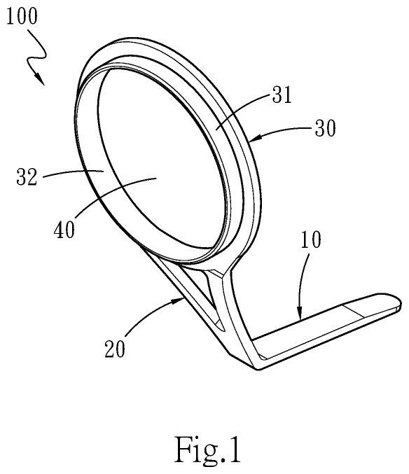

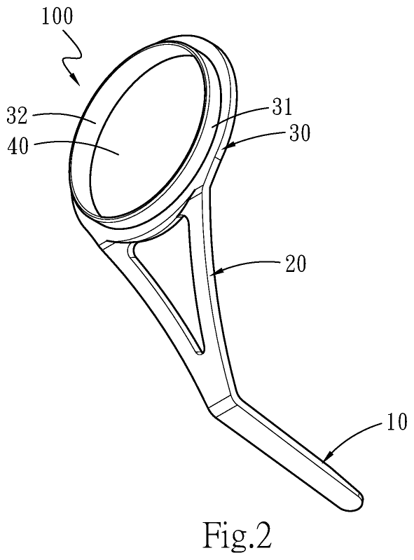

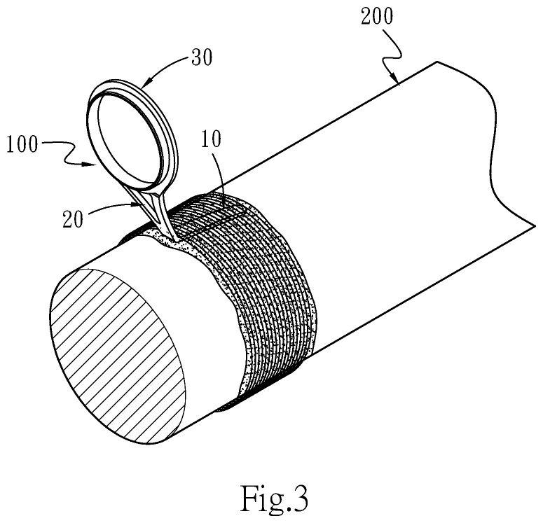

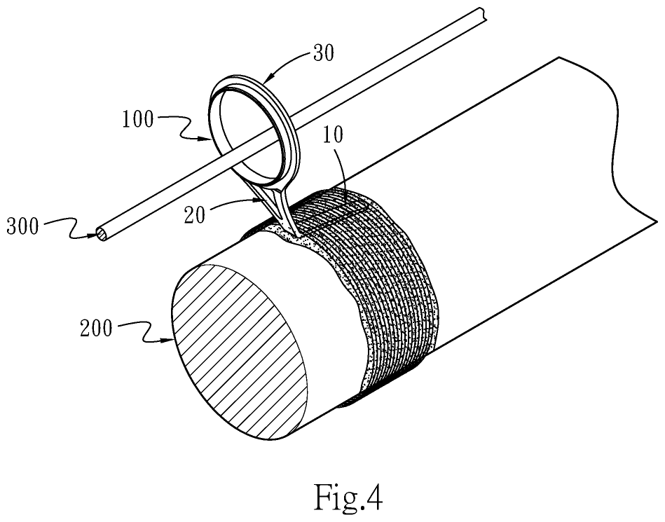

Please refer to FIG. 1, FIG. 2, FIG. 3, and FIG. 4. The present invention provides a fishing line guide 100, and the fishing line guide 100 can be arranged with a fishing rod 200 and a fishing line 300. As shown in FIG. 4, a plurality of fishing line guides 100 are provided along the axial direction of the fishing rod 200, and each of the plurality of fishing line guides 100 are aligned with one another, so that the fishing line 300 is passed through. The fishing line guide 100 of the present invention is provided on a various types of fishing rod 200, and the above uses are by way of example only and not to limit the scope of the present invention.

Specifically, the fishing line guide 100 includes a fixing part 10, a bending part 20 connected with the fixing part 10, a ring frame 30 connected with the bending part 20, and a guide ring channel 40 penetrating through the ring frame 30 and passed through by the fishing line 300. The fixing part 10 is fixed on a rod body of the fishing rod 200, and a fixing mode may be in a binding mode, a tenon connection mode, and so on. Further, in the embodiment, the fishing line guide 100 is fixed on the fishing rod 200 in a binding mode and then is fixed by gluing. Further, as the fixing part 10 and the bending part 20 is fitted with the fishing rod 200, the shape of the fixing part 10 is not limited to a single-column shape, a bifurcated shape, a polygonal shape, and the like.

The fishing line guide 100 of the present invention is characterized in that the ring frame 30 includes a protrusion 31 extending opposite to the fixing part 10, wherein an inner surface of the protrusion 31 is provided with a line guide surface 32. The fishing line 300 is abutted against the line guide surface 32 when being forced, so that local excessive friction is avoided, and the fishing line 300 is prevented from being broken in the pulling process. Furthermore, the line guide surface 32 of the present embodiment is provided on an inner surface of the protrusion 31, that is, the line guide surface 32 is provided corresponding to the guide ring channel 40, and the radian of the line guide surface 32 is made according to market demands, without limitation. The surface of the ring frame 30 may be coated with a reinforcing layer (not shown in the drawing), and the reinforcing layer may be a plated film, a hardened portion, etc. produced after plating or heat treatment. The plating material may be a metal material with high hardness coefficient such as titanium alloy, chromium alloy and the like. In the present invention, by the ring frame 30 and the protrusion 31 are integrally formed and extracted in a progressive stamping manner with using a stamping machine, the protrusion 31 and the line guide surface 32 are formed. In other words, the protrusion 31 is integrally stamped and formed from the ring frame 30 in a progressive stamping manner by using a stamping machine. Due to the fact that the ring frame 30 and the protrusion 31 are integrally formed, the ring frame 30 and the protrusion 31 only need to be subjected to a stamping process during manufacturing. Thus, the complicated procedure in the prior art that needs to firstly manufacture the frame and then embed the ring body is improved, also, the defective rate of products is reduced and the cost reduction is controlled, so that the productivity is effectively improved.

In view of the above, the line guide surface 32 of the fishing line guide 100 of the present invention is integrally formed without a fitting or assembling process. Also, the ring frame 30 is integrally formed with the line guide surface 32. Therefore, the component manufactured by adopting the stamping manner not only provides an advantage of improving the manufacturing process, but also achieves the beneficial effect of changing the radian according to requirements. Besides, the applicability is improved, the defective rate of products is reduced and the cost reduction can be controlled, so that the productivity is effectively improved.

What is claimed is:

1. A fishing line guide, comprising:
a fixing part;
a bending part connected with the fixing part;
a ring frame connected with the bending part, comprising a protrusion extending opposite to the fixing part, wherein an inner surface of the protrusion is provided with a line guide surface, and the protrusion and the line guide surface are integrally formed and drawn from the ring frame in a stamping manner; and
a guide ring channel penetrating through the ring frame and allowing a fishing line to pass through.

2. The fishing line guide of claim 1, wherein a surface of the ring frame is coated with a reinforcing layer.
